(19) United States
(12) Patent Application Publication
(10) Pub. No.: US 2003/0172218 A1
(43) Pub. Date: Sep. 11, 2003

(54) Systems, devices, and methods for transferring data between an intelligent docking station and a handheld personal computer

(76) Inventors: Bryan Scott, Dallas, TX (US); Ramon Perales, Dallas, TX (US)

Correspondence Address: Steven W. Thrasher, 391 Sandhill Dr., Richardson, TX, 75080, US

(21) Appl. No.: 10/093,921

(22) Filed: Mar. 8, 2002

(51) Int. Cl. G06F 13/00

(52) U.S. Cl. 710/303

(57) ABSTRACT

The invention transfers a data element between a universal docking station and a handheld computer.

### RELATED APPLICATIONS

This patent application is related to and claims priority from co-owned and assigned U.S. patent application Ser. No. 10/051,264 to Scott, et al. entitled System for Integrating an Intelligent Docking Station with a Handheld Personal Computer, filed on Feb. 1, 2002. This patent application is also related to and claims priority from co-owned and assigned U.S. patent application Ser. No. 10/061,997 to Scott, et al. entitled Method for Integrating an Intelligent Docking Station with a Handheld Personal Computer, filed on Feb. 1, 2002.

### REFERENCED APPLICATIONS

The invention is related to U.S. Pat. No. 6,088,752 to Ahem, et al, entitled Method and apparatus for exchanging information between buses in a portable computer and docking station through a bridge employing a serial link, which was filed on Aug. 6, 1998 and which issued on Jul. 11, 2000, and which is incorporated herein by reference. The invention is further related to U.S. Pat. No. 6,256,691 to Moroz, et al., entitled Universal Docking Station, which was filed on Jan. 11, 2000 and which issued on Jul. 3, 2001, and which is incorporated herein by reference.

### BACKGROUND OF THE INVENTION

1. Technical Field

The present invention generally relates to desktop, mobile, or portable computing.

2. Problem Statement

In part because of the ability to make businesses and households more efficient, personal computers (PCs) have earned a solid place in homes and businesses. However, PCs are typically bulky, require large amounts of power, and occupy a large amount of surface area, called a “footprint.”

Computers small enough to be held in a single hand, called “handhelds” or personal digital assistants (PDAs), provide significant computing power in a small device that uses relatively little power. Unfortunately, handhelds do not offer the most user-friendly input/output devices, such as a keyboard and mouse. Instead, a user of a handheld must be content with using a stylus or other data entry device. Accordingly, it is desirable to provide a device, system, and method for integrating the convenience of a handheld into a PC-type input/output environment. The invention provides such devices, systems, and methods.

### SUMMARY OF THE INVENTION

The invention achieves technical advantages transferring a data element from a device to a handheld computer, and from a handheld computer to a device. The invention may be embodied as a method. In general, the method receives a device-enabled data element at a docking station enabled co-processor, performs a driver conversion to convert the device-enabled data element into a bus-enabled data element, and places the bus-enabled data element on a handheld compatible bus. In one embodiment, the method may transform a data packet by detecting an input packet, retrieving a packet identifier (ID) from the input packet, and dispatching the input packet to a device driver enabled on the packet ID, the device driver capable of converting the input packet from a handheld computer packet type to a device packet type.

The invention, in another embodiment, is also a system that enables the method. For example, the invention is in one embodiment a software system for an intelligent docking station. The software system includes an IDS operating system, a top-level device driver, the top-level device driver capable of assembling handheld device-enabled data elements on an input packet and capable of formatting IDS device-enabled data elements for the handheld low-level device driver on an output packet, a communication driver, the communication device driver capable of sending and receiving bus-enabled data elements, and a low-level device driver (the low-level device driver being capable of controlling peripheral devices with device-enabled data elements.) The IDS operating system is enabled to assemble data elements from the communication driver and format the data elements for the low-level device driver.

In yet another embodiment, the invention is a device. As a device, the invention is an intelligent docking station. The intelligent docking station includes a co-processor capable of converting a handheld-enabled data element into a device enabled data element, a bus interface coupled to the co-processor, and a port coupled to the co-processor. The invention may also be embodied as a system that incorporates the intelligent docking station.

The methods may be embodied as manufactured devices. For example, the methods may be placed on a computer readable medium, such as a computer diskette, CD ROM, or other memory device. In addition, the methods maybe placed in a computer memory or hard-written onto a processor to enable a general computing device to be transformed into a specific computing machine, or specific system. A computer system may be set up as a network capable of executing any of the methods. One such network could be the Internet, and the network could employ an application service provider. In addition, the invention may be embodied as one or more data signals that transform a general network into a task-specific network (or, task specific distributed machine).

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. The invention is limited only by the claims.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 depicts an intelligent docking station system;

FIG. 2 shows a software system for an intelligent docking station; and

FIG. 3 illustrates a block-flow diagram of an intelligent docking station (IDS) algorithm;

FIG. 4 is a logic-flow diagram of a PDA docking algorithm;

FIG. 5 is a block-flow diagram of an IDS docking algorithm; and

FIG. 6 illustrates one embodiment of an intelligent docking station system which incorporates at least one aspect of the referenced patents

### BRIEF DESCRIPTION OF PRIOR ART FIGURES REFERENCED IN THE DETAILED DESCRIPTION

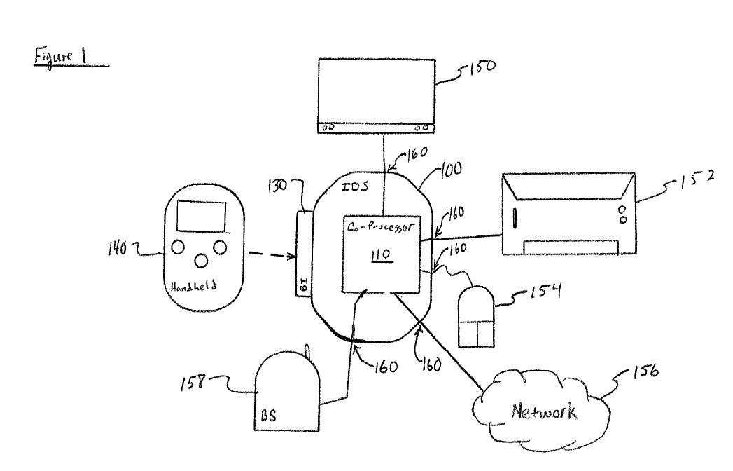

FIG. 1 ('752 prior art) is a schematic block diagram showing a bridge split by a link within the bridge, in accordance with principles of the present invention;

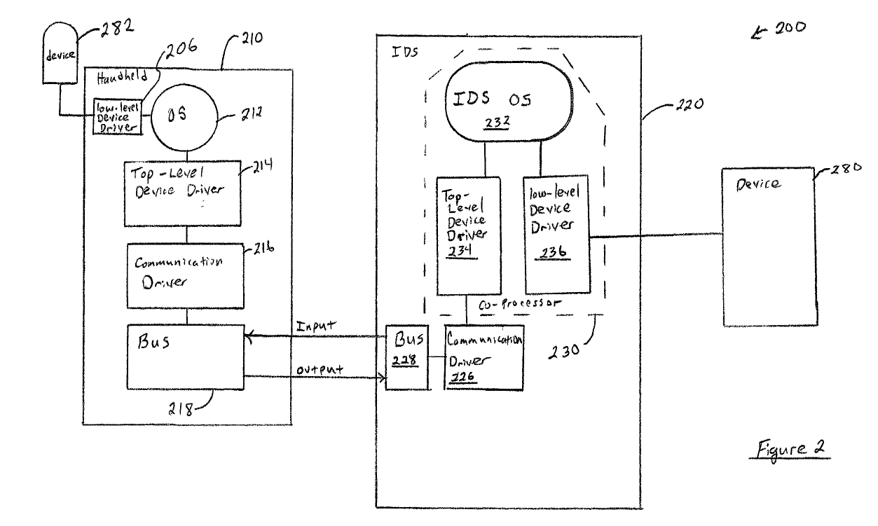

FIG. 2 ('752 prior art) is a schematic block diagram showing a bridge in accordance with principles of the present invention using the link of FIG. 1 ('752 prior art);

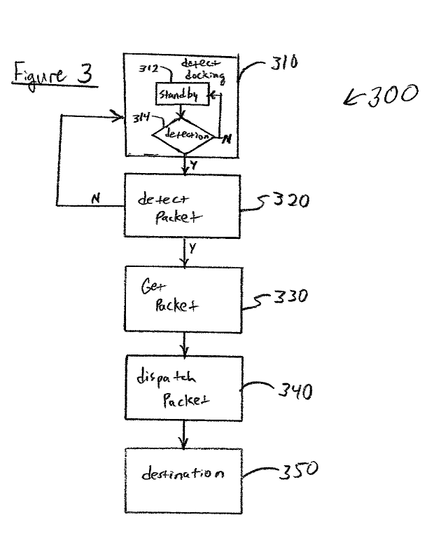

FIG. 3 ('752 prior art) is a schematic block diagram showing the bridge of FIG. 2 ('752 prior art) used in a docking system in accordance with principles of the present invention;

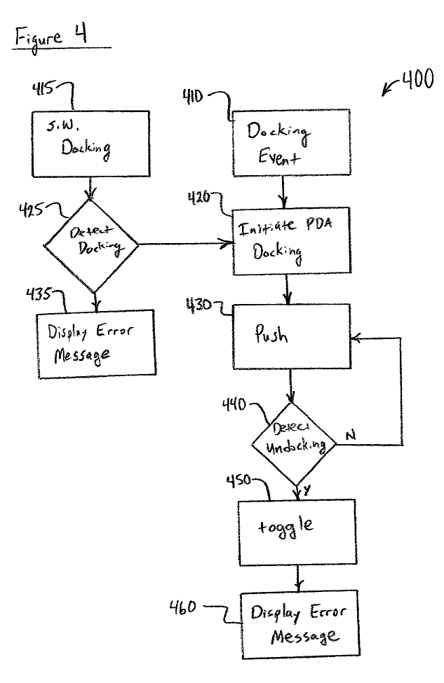

FIG. 4 ('752 prior art) is a cross-sectional view of the cable of FIG. 3 ('752 prior art);

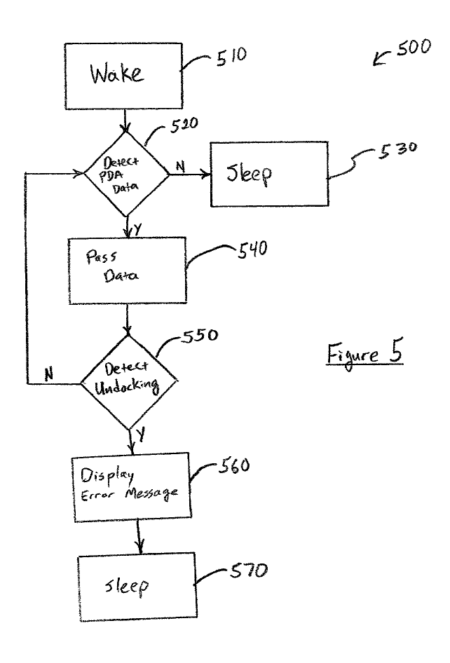

FIG. 5 ('752 prior art) is a schematic illustration of the bridge of FIG. 3 ('752 prior art) shown connected to a portable computer and a variety of peripheral devices; and

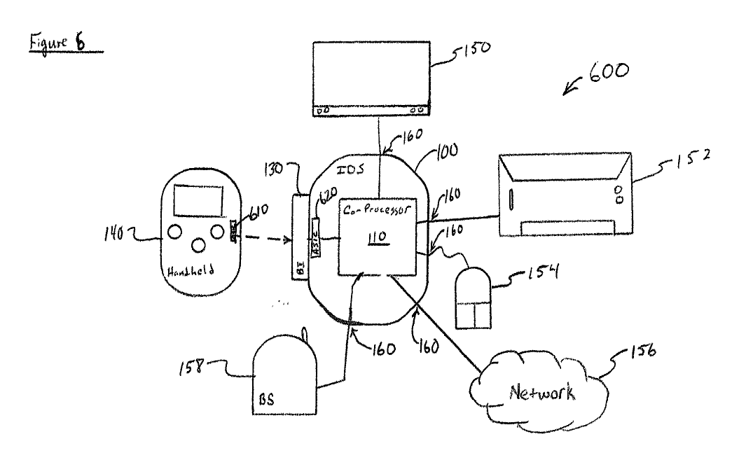

FIG. 6 ('752 prior art) shows a docking station similar to that of FIG. 5 ('752 prior art) but with the portable computer modified to contain an application-specific integrated circuit designed to support a link to the docking station.

FIG. 1 ('691 prior art) is a block diagram showing a docking station in accordance with one embodiment of the invention connected to various peripheral devices and connected to a computer via a standard universal interface.

FIG. 2 ('691 prior art) is a more detailed block diagram of the docking station represented in FIG. 1 ('691 prior art).

FIG. 3 ('691 prior art) is a flow chart showing a method of initializing a device driver into an operating system.

FIG. 4 ('691 prior art) is a flow chart of steps that occur in handling insertion of a PCMCIA card into a PCMCIA port of a computer.

FIG. 5 ('691 prior art) is a flow chart of steps that occur when the docking station shown in FIG. 1 ('691 prior art) causes an interrupt on the computer requesting service for one of the peripheral devices.

FIG. 6 ('691 prior art) is a timing diagram showing the write timing used to interface multiple peripheral devices to the PCMCIA port.

FIG. 7 ('691 prior art) is a timing diagram showing the read timing used to interface multiple peripherals to the PCMCIA port.

### DETAILED DESCRIPTION

Interpretative Considerations

When reading this section (An Exemplary Embodiment of a Best Mode, which describes an exemplary embodiment of the best mode of the invention, hereinafter “exemplary embodiment” or “Detailed Description”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act maybe used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section.

Computer Systems as Software Platforms

A computer system typically includes hardware capable of executing machine-readable instructions, other hardware, as well as the software for executing acts (typically machine-readable instructions) that produce a desired result. In addition, a computer system may include hybrids of hardware and software, as well as computer sub-systems. The way hardware is organized within a system is known as the system's architecture (discussed below).

Software includes machine code stored in memory, such as RAM or ROM, or machine code stored on devices (such as floppy disks, or a CD ROM, for example). Software may include executable code, an operating system, or source or object code, for example. In addition, software encompasses any set of instructions capable of being executed in a client machine or server—and, in this form, is often called a program or executable code.

Programs often execute in portions of code at a time. These portions of code are sometimes called modules or code-segments. Often, but not always, these code segments are identified by a particular function that they perform. For example, a counting module (or “counting code segment”) may monitor the value of a variable. Furthermore, the execution of a code segment or module is sometimes called an act. Accordingly, software may be used to perform a method that comprises acts. In the present discussion, sometimes acts are referred to as steps to help the reader more completely understand the exemplary embodiment.

Software also includes description code. Description code specifies variable values and uses these values to define attributes for a display, such as the placement and color of an item on a displayed page. For example, the Hypertext Transfer Protocol (HTTP) is the software used to enable the Internet and is a description software language.

Hybrids (combinations of software and hardware) are becoming more common as devices for providing enhanced functionality and performance to computer systems. A hybrid is created when traditionally software functions are directly manufactured into a silicon chip—this is possible since software may be assembled and compiled into ones and zeros, and, similarly, ones and zeros can be represented directly in silicon. Typically, the hybrid (manufactured hardware) functions are designed to operate seamlessly with software. Accordingly, it should be understood that hybrids and other combinations of hardware and software are also included within the definition of a computer system and are thus envisioned by the invention as possible equivalent structures and equivalent methods.

Computer sub-systems are combinations of hardware or software (or hybrids) that perform some specific task. For example, one computer sub-system is a soundcard. A soundcard provides hardware connections, memory, and hardware devices for enabling sounds to be produced and recorded by a computer system. Likewise, a soundcard may also include software needed to enable a computer system to “see” the soundcard, recognize the soundcard, and drive the soundcard.

Sometimes the methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Description of the Drawings

Reference is now made to the figures, and in particular with reference to FIG. 1, which depicts an intelligent docking station system. The intelligent docking station system comprises an intelligent docking station 100, which is capable of coupling to a handheld computer 140 or a device. In general, the intelligent docking station 100 includes a co-processor 110 capable of converting a handheld computer-enabled data element into a device enabled data element, a bus interface (BI) 130 coupled to the co-processor 110, and a port 160, coupled to the co-processor 110.

In one embodiment, the intelligent docking station 100 includes logic (not shown) that is coupled between each port 160 and the co-processor 110. The BI 130 may be any bus system used in any handheld computer, and is preferably a bi-directional bus such as Card Bus, PCMCIA, PCI, VME, ISA, SCSI, or a wireless bus. Similarly, the BI 130 may be simulated via USB, Firewire, or NIC, for example. The logic is employed to provide additional functionality to the intelligent docking station 100.

For example, the logic could be a modem, thus enabling the intelligent docking station 100 to connect with special devices or networks, such as the base station (BS) device 158. Other devices that may be coupled to the co-processor 110 through corresponding logic, which is preferably device specific logic, include a monitor 150, a printer 152, a mouse 154, a data storage device (not shown), or a network 156, such as the Internet. Of course, it should be understood that the devices provided herein are exemplary only, and any type of input or output device that is connectable to a PC is also connectable to the intelligent docking station 100 using the invention.

In another embodiment, the invention is an intelligent docking station system. The system includes a docking station 100 having a co-processor 110 capable of converting a hand held-enabled data element into a device enabled data element, a bus 130 that couples the docking station 100 to a handheld computer 140, and a device coupled to the docking station 100.

In yet another embodiment, the invention provides for the intelligent docking system to communicate with a personal digital assistant (or, hand held computer) via a link, such as a wireless link, a bridge, or a bus. In a preferred embodiment, the link interfaces the IDS to the PDA having data on a bus via a PCMCIA bus by providing data to be written to the IDS on the PCMCIA bus without waiting for the end of any current transactions. In another embodiment, the link sends information between the PDA and the IDS over a single connection by serial transmission through a link in a format different from that of the PDA and the IDS, and allows the PDA to individually address a device in communication with the IDS, wherein the PDA uses substantially the same type of addressing as is used to access a device directly using only the IDS. In a further embodiment, the link interfaces the IDS to the PDA when the PDA has data on a bus via a PCMCIA bus, by a) providing data to be written to the PDA on the PCMCIA bus without waiting for the end of any current transactions, and b) writing the data to the PDA via the PCMCIA bus. In addition, information may be sent between the IDS and the PDA over a single connection by serial transmission through a link in a format different from that of the PDA and the IDS, and the system may allow a peripheral device to individually address the PDA in communication with the IDS, wherein the peripheral device uses substantially the same type of addressing as is used to access the IDS.

FIG. 2 shows a software system 220 for an intelligent docking station. The software system for an intelligent docking station (the software system 220) 220 includes an IDS operating system (IDS OS) 232, which could be any common embedded or handheld operating system. Common operating systems include QNX RTOS, WindRiver VxWorks, Lineo Embeddix, Palm OS, Windows CE, Windows for Pocket PC, EPOC, and other Linux variants, for example. In addition, the software system 220 includes a communication device driver 226 which is capable of sending and receiving bus-enabled data elements, a low-level driver 236 that is capable of sending and receiving device-enabled data elements, and a top-level device driver 234 capable of assembling handheld device-enabled data elements on an input packet and capable of formatting IDS device-enabled data elements for the handheld low-level device driver 206 on an output packet.

Top level device drivers typically perform at least two functions. First, when a top level device driver receives an output data element from a communication driver, it gathers a packet and/or packet identification information and assembles a device-enabled data element that is understandable by a low level device driver. In addition, prior to sending input data elements received from a low level device driver, the top level device driver formats the data for an appropriate low level device driver. The low level device driver then passes the data element to a specific device, alters the data element in some way, or invokes an operating system to do something with the device.

The low-level device driver 236 is typically a device specific driver that sends and/or receives data elements from a specific device, such as a monitor or keyboard (in which case the device driver is called a display device driver or a keyboard device driver). In a preferred embodiment, the IDS operating system 232 is enabled to format the device-enabled data elements for the low-level handheld low-level device driver 206 and forward the formatted device-enabled data elements to the communication driver 226. In a preferred embodiment, the IDS OS 232, the top-level device driver 234, and the low-level device driver 236 are maintained on the co-processor 230. However, separate logic, software, or firmware may be used to accomplish the same conversions.

Other elements of the software system 220 include a bus module 228 which controls traffic across a bus that couples the IDS to a handheld computer. In addition, the software system 220 may include logic (not shown) for providing specific functionality to a device module 280.

The invention is also a software system, embodied as a PDA system 210. The PDA system 210 includes any embedded or handheld computer operating system 210, which may be any of the systems discussed above, or any other common embedded or handheld computer operating system. The PDA system 210 also includes a handheld-enabled low-level device driver 206 that is capable of transferring handheld-enabled data directly between the PDA system 210 and a device, such as a monitor or a keyboard. The PDA system 210 has a top-level device driver 214 for formatting hand held-enabled device data to IDS specific low-level device data (236). In addition, the PDA system 210 has a communication driver 216 for converting the information normally handled by the device driver 214 into bus-enabled data that can be transferred across a bus that couples the handheld device to an intelligent docking station. Of course, although the communication driver 216 discussed above is described as software, the communication driver 216 may be embodied in firmware, or maintained within the PDA OS 212.

Exemplary Methods

FIG. 3 illustrates a block-flow diagram of an intelligent docking station (IDS) algorithm 300. In general, the IDS algorithm 300 can control a data flow between a handheld computer and a device. As a method of transferring a data element from a device to a handheld computer, after detecting a docking condition, and activating a communication driver in response to the docking condition (a docking detection act), the IDS algorithm 300 receives a device-enabled data element at a docking station enabled co-processor in a receive device data element act. The device-enabled data element is generated by a specific device, or, may be generated by device simulation software.

Next, if necessary, a top-level device driver reformats the device data element to the handheld device-enabled data element, which is then converted into a bus-enabled data element in a convert data element act by the communication driver. The conversion may take place in the IDS OS of the intelligent docking station, in separate software, or in firmware. Then, the IDS algorithm 300 places the bus-enabled data element on a handheld compatible bus in a bus placement act. In a system implementation of the IDS algorithm 300, the bus-enabled data element is received in a handheld computer, and the bus-enabled data element is converted into a handheld data element in a convert to handheld act.

Similarly, the IDS algorithm 300 can transform data from a handheld to a device. Accordingly, the IDS algorithm 300 detects a docking condition in a detect docking act. Then, when handheld-enabled data is to be sent to a device, a handheld-enabled data element is converted into a bus-enabled data element via a communication driver in a bus enable act. Then, in a bus placement act, the bus-enabled data element is placed on a handheld compatible bus. Next, as a conversion act, the bus-enabled data element is received at a docking station enabled co-processor, and a driver converts the bus-enabled data element into a device-enabled data element. Accordingly, the device-enabled data is placed on an output port in a send data act.

The preferred IDS algorithm 300 is specifically illustrated by the block-flow diagram of FIG. 3. First, the IDS algorithm 300 detects a docking condition in a detect docking act 310. Accordingly, within a detect docking act 310 a communication driver in the IDS waits in a low-power standby state act 312, once docked the handheld will send an initiation command for the IDS to initialize the IDS docking sequence 314. If no initialization sequence is detected as illustrated by the “n” arrow designation, then the IDS algorithm 300 returns to a standby state act 312, which occurs between detection sequences. Of course, in the event of wireless docking, a wireless device will be detected by the IDS.

If the detection sequence 314 is initiated when the handheld computer is docked with an intelligent docking station, then the IDS algorithm 300 proceeds to a detect packet act 320. In the detect packet act 320 the IDS detection algorithm 300 queries ports on the IDS as well as the bus that couples the handheld computer to the IDS. If no packet is detected, then the IDS detection algorithm 300 returns to the detect docking act 310.

If a packet is detected on a port or a bus in the detect packet act 320, in one embodiment by activating an Input Data line, then the IDS detection algorithm 300 proceeds to retrieve at least a packet identifier (ID) in a get packet act 330. Alternatively, the IDS detection algorithm 300 may gather the entire packet in the get packet act 330. Next, in a dispatch packet act 340, the packet is sent to a communication driver.

Finally, in a destination act 350, in the event that the packet is headed for a device, the handheld OS sends the packet to the appropriate device via the appropriate port. Similarly, if in the destination act 350, the packet is destined for a handheld computer, the IDS destination algorithm 300 send the packet to the handheld OS for further processing as is known in the art.

For example, one may follow the flow of a graphics packet from the handheld computer to a display device. First, a communication driver detects that a docking condition has occurred in a detect docking act 310. Then, the IDS OS detects that a packet has arrived on the bus by detecting a signal on an Input Data line. Accordingly, the IDS OS retrieves at least the packet ID, and knows from this packet ID that the packet should be delivered to a display device driver, and so dispatches the display device driver to convert the graphics packet from a bus-enabled data element to a display device-enabled data element. Finally, the IDS OS sends the display device-enabled data element to the display device.

Similarly, one may follow the flow of a packet from a keyboard to the handheld computer. First, a communication driver detects that a docking condition has occurred in a detect docking act 310. Accordingly, the IDS OS retrieves at least the packet ID, and knows from this packet ID that the packet is a keyboard stroke or a series of keyboard strokes, and so the IDS OS dispatches the keyboard device driver to convert the device data element packet from a keyboard data element into a bus-enabled data element. Then, the IDS OS directs the IDS enabled communication driver to place the bus-enabled data element on the bus. Finally, the communication driver actually places the bus-enabled data element on the bus.

In one embodiment, the communication drivers are used to negotiate docking. Accordingly, FIG. 4 is a logic-flow diagram of a PDA docking algorithm 400. The PDA docking algorithm 400 begins with either a docking event act 410 or a software (S.W.) docking act 415. In the docking event act 410 a docking of a PDA and an IDS is initiated via hardware, such as a signal on a pin setting a flag, or for a wireless network a proximity detection is achieved wirelessly, for example. A docking event may also be defined as an undocking of a PDA with an IDS. Next, in an initiate PDA act 420, the PDA OS toggles from PDA-based top-level device drivers, to top-level IDS device drivers, where appropriate. For example, the PDA OS toggles from PDA-based top-level video device drivers, to top-level IDS video device drivers. Device drivers are toggled in the preferred order of video device drivers, keyboard device drivers, mouse device drivers, and other device drivers. Of course, it is anticipated that as technology develops, other input and output devices will emerge, and those may be inserted into this hierarchy where appropriate.

In the SW docking act 415, a user initiates a search for an IDS connection in the PDA software. Next, in a detect docking query 245, the PDA, and preferably the PDA's communication driver, “pings”, queries various pins and/or caches, or otherwise test the connection between the PDA and the IDS until an indication of docking is found, or until a time-out event has occurred. A time-out is a predetermined period of time, such that if no docking connection is detected during the predetermined period of time, a time-out event is said to have occurred. If no docking connection is detected by the time a time-out event has occurred in the detect docking query 425, then the PDA docking algorithm 400 proceeds to a display error message act 435 wherein the PDA OS directs the displaying of an error message on the PDA's display. If in the detect docking query 425 a docking connection is detected, then the PDA docking algorithm 400 proceeds to the initiate PDA act 420.

Following the initiate PDA act 420, the PDA docking algorithm 400 advances to a push act 430. In the push act 430, the communications driver in the PDA pushes a predetermined quantity of data to the IDS using any one of a number of available protocols. Alternatively, protocols may be selected dynamically to increase the efficiency of data transfer. The push act 430 continues until an interrupt event is detected, or until a predetermined period of time has passed without a data transfer. Thus, if an interrupt event is detected or a predetermined period of time passes, next, in a detect undocking query 440, the PDA docking algorithm 400 queries the appropriate pins and caches to determine if the PDA and the IDS are docked. Undocking events are also preferably detected by a communication driver in the PDA. In the event the PDA and the IDS are docked, no undocking is detected and the PDA docking algorithm 400 returns to the push act 430 as shown by the “N” decision path. If, however, after a predetermined period of time no data or other indication of a connection is detected in the detect undocking query, it is determined that an undocking event has occurred, and the PDA docking algorithm 400 moves to the “y” decision path to a toggle act 450.

In the toggle act 450 the PDA OS reverts back to the PDA-based top level device drivers. For example, the PDA goes from using the IDS-based video device driver to the PDA-based video device driver. Following the toggle act 450, an error message is displayed on the PDA screen in a display error message act 460. In one embodiment, an error message states “Error: PDA Needs Redocking”.

Docking initiated events also occur in the IDS. FIG. 5 is a block-flow diagram of an IDS docking algorithm 500. By default, an IDS is in a “sleep” state, in which power to the processor and the IDS is minimized. However, when a docking is detected the IDS “wakes” up and becomes fully powered in a wake act 510. Docking may be detected when a flag-pin is appropriately set, when something is received on the IDS port, or when a wireless sequence is detected, for example. Then, a detect PDA data query 520 takes place. In the PDA data query 520, the IDS communication checks to see if data is present on the IDS port. If data is not present, as illustrated by the “N” decision, then the IS docking algorithm 500 determines that no docking as actually occurred and returns the IDS to a sleep mode in a sleep act 530. If, on the other hand, the PDA data query 520 detects that data is present on the IDS port, by, for example, examining the port for a packet header, and evaluating the packet header to determine that the packet is intended for the IDS, then the IDS docking algorithm 500 proceeds to a pass data act 540, as indicated by the “Y” decision. In the pass data act 540 the communication driver moves packets from the IDS port to the IDS OS or other appropriate location as indicated by the packet header. Likewise, in the pass data act 540 the communication driver moves packets to the IDS port from appropriate location of the IDS.

The pass data act 540 continues until an undocking condition is detected (such as flag indicating undocking is received), or until a predetermined period of time has passed without data transfer. Thus if an undocking condition is detected or a predetermined period of time passes without data transfer, then the IDS docking algorithm 500 proceeds to a detect undocking query 550. In the detect undocking query 550 the communications driver queries the appropriate pins and caches to determine if the IDS is docked with the PDA. The detect undocking query 550 may also be performed by the IDS OS. In the event the PDA and the IDS are docked, no undocking is detected and the IDS docking algorithm 500 returns to the detect PDA act 520, as shown by the “N” decision path. If, however, after a predetermined period of time, no data or other indication of a docking is detected, it is assumed that an undocking event has occurred, and the IDS docking algorithm 500 proceeds along the “y” decision path to a display error message act 560. An error message is displayed on the monitor screen attached to the IDS, such as “Error: PDA Needs Redocking”. Then, in a sleep act 570, the IDS returns to a sleep mode.

Exemplary Methods for Transmitting Data Between a PDA and an IDS

U.S. Pat. No. 6,088,752 to Ahem, et al, entitled Method and apparatus for exchanging information between buses in a portable computer and docking station through a bridge employing a serial link, which was filed on Aug. 6, 1998 and which issued on Jul. 11, 2000, and which is incorporated herein by reference discloses a method of transferring data between a mobile computer and a regular, prior-art (sometimes called a “dumb”) docking station (the '752 patent). Relevant sections of the '752 patent are here presented, with figures provided for the '752 patent designated below by “('752 prior art)”:

Referring to FIG. 1, a bridge is shown connecting between a first bus 10 and a second bus 12 (also referred to as primary bus 10 and secondary bus 12). These buses may be PCI or PCMCIA 32-bit buses, although other types of buses are contemplated and the present disclosure is not restricted to any specific type of bus. Buses of this type will normally have address and data lines. In some cases, such as with the PCI bus, address and data are multiplexed onto the same lines. In addition, these buses will have signaling lines for allowing devices on the bus to negotiate transactions. For the PCI standard, these signaling lines will include four lines that are used either for control or byte enabling (C/BE[3:0]). Others signaling lines under the PCI standard exist for gaining control over the bus, for handshaking, and the like (e.g., FRAME#, TRDY#, IRDY#, STOP#, DEVSEL#, etc.)

Buses 10 and 12 are shown connecting to a first interface means 14 and 30 second interface means 16, respectively (also referred to as interfaces 14 and 16). Bus information selected for transmission by interfaces 14 and 16 are loaded into registers 18 and 20, respectively. Incoming bus information that interfaces 14 and 16 select for submission to the buses are taken from registers 22 and 24, respectively. In one embodiment, registers 18-24 are each 16.times.38 FIFO registers, although different

[image]

[image]

[image]

[image]

types of registers having different dimensions may be used in alternate embodiments.

In this embodiment, registers 18-24 are at least 38 bits wide. Thirty six of those bits are reserved for the 4 control bits (C/BE#[3:0]) and the 32 address/data bits (AD[31:0]) used under the PCI bus standard. The remaining two bits can be used to send additional tags for identifying the nature of the transaction associated therewith. Other bits may be needed to fully characterize every contemplated transaction. Transactions can be tagged as: addressing cycle; acknowledgment of a non-posted write; data burst; end of data burst (or single cycle). Thus outgoing write transactions can be tagged as a single cycle transaction or as part of a burst. Outgoing read requests can also be tagged as part of a burst with a sequence of byte enable codes (C/BE) for each successive read cycle of the burst. It will be appreciated that other coding schemes using a different number of bits can be used in other embodiments.

The balance of the structure illustrated in FIG. 1 is a link designed to establish duplex communications between interfaces 14 and 16 through registers 18-24. For example, encoder 28 can accept the oldest 38 bits from register 20 and parse it into five bytes (40 bits). The extra two bits of the last byte are encoded to signify the interrupts, status signals and error signals that may be supplied from block 34.

Each of these five bytes is converted into a 10 bit frame that can carry the information of each byte, as well as information useful for regulating the link. For example, these frames can carry comma markers, idle markers, or flow control signals, in a well-known fashion. A transceiver system working with bytes that were encoded into such 10 bit frames is sold commercially by Hewlett Packard as model number HDMP-1636 or -1646. Frames produced by encoder 28 are forwarded through transmitter 44 along simplex link 46 to receiver 48, which supplies the serial information to decoder 30. Likewise, encoder 26 forwards serial information through transmitter 38 along simplex link 40 to receiver 42, which supplies the serial information to decoder 32.

Flow control may be necessary should FIFO registers 22 or 24 be in danger of overflowing. For example, if FIFO register 22 is almost full, it supplies a threshold detect signal 36 to encoder 26, which forwards this information through link 40 to decoder 32. In response, decoder 32 issues a threshold stop signal 50 to encoder 28, which then stops forwarding serial information, thereby preventing an overflow in FIFO register 22. In a similar fashion, a potential overflow in FIFO register 24 causes a threshold detect signal 52 to flow through encoder 28 and link 46 to cause decoder 30 to issue a threshold stop signal 54, to stop encoder 26 from sending more frames of information. In some embodiments, the system will examine the received information to determine if it contains transmission errors or has been corrupted in some fashion. In such event the system can request a retransmission of the corrupted information and thereby ensure a highly reliable link.

In this embodiment, elements 14, 18, 22, 26, 30, 38 and 48 are part of a single, application specific integrated circuit (ASIC) 56. Elements 16, 20, 24, 28, 32, 42 and 44 are also part of an ASIC 58. As described further hereinafter, first ASIC 56 and second ASIC 58 have an identical structure but can be operated in different modes. It will be appreciated that other embodiments may not use ASIC's but may use instead alternate circuitry, such as a programable logic device, or the like. As shown herein, ASIC 56 is operating in a mode designed to service primary bus 10, and (for reasons to be described presently) will be sending outputs to block 57. In contrast block 34 of ASIC 58 will receive inputs from block 34.

Encoders 26 and 28 have optional parallel outputs 27 and 29, respectively, for applications requiring such information. Also for such applications, decoders 30 and 32 have parallel inputs 31 and 33, respectively. These optional inputs and outputs may be connected to an external transceiver chip, such as the previously mentioned device offered by Hewlett Packard as model number HDMP-1636 or -1646. These devices will still allow the system to transmit serial information, but by means of an external transceiver chip. This allows the user of the ASIC's 56 and 58 more control over the methods of transmission over the link.

Referring to FIG. 2, previously mentioned ASIC's 56 and 58 are shown in further detail. The previously mentioned encoders, decoders, transmitters, receivers, and FIFO registers are combined into blocks 60 and 62, which are interconnected by a duplex cable formed of previously mentioned simplex links 40 and 46. Previously mentioned interface 14 is shown connected to primary bus 10, which is also connected to a number of bus-compatible devices 64. Similarly, previously mentioned interface 16 is shown connected to secondary bus 12, which is also connected to a number of bus-compatible devices 66. Devices 64 and 66 may be PCI-compliant devices and may operate as memory devices or input/output devices.

Interface 14 a shown connected to a first register means 68, which acts as a configuration register in compliance with the PCI standard. Since this system will act as a bridge, configuration registers 68 will have the information normally associated with a bridge. Also, configuration registers 68 will contain a base register and limit register to indicate a range or predetermined schedule of addresses for devices that can be found on the secondary bus 12. Under the PCI standard, devices on a PCI bus will themselves each have a base register, which allows mapping of the memory space and/or I/O space. Consequently, the base and limit registers in configuration registers 68 can accommodate the mapping that is being performed by individual PCI devices. The information on configuration registers 68 are mirrored on second configuration register 67 (also referred to as a second configuration means). This makes the configuration information readily available to the interfaces on both sides of the link.

In this embodiment, ASIC 58 has an arbiter 70. Arbiters are known devices that accept requests from masters on secondary bus 12 for control of the bus. The arbiter has a fair algorithm that grants the request of one of the contending masters by issuing it a grant signal. In this hierarchical scheme, secondary bus 12 requires bus arbitration, but primary bus 10 will provide its own arbitration. Accordingly, ASIC 56 is placed in a mode where arbiter 72 is disabled. The modes of ASIC's 56 and 58 are set by control signals applied to control pins 74 and 76, respectively. Because of this mode selection, the signal directions associated with blocks 57 and 34 will be reversed.

In this embodiment, ASIC 58 is in a mode that implements a third bus 78. Bus 78 may follow the PCI standard, but is more conveniently implemented in a different standard. Bus 78 connects to a number of devices that act as a port means. For example, devices 80 and 82 can implement PS/2 ports that can connect to either a mouse or a keyboard. Device 84 implements an ECP/EPP parallel port for driving a printer or other device. Device 86 implements a conventional serial port. Devices 80, 82, 84 and 86 are shown with input/output lines 81, 83, 85 and 87, respectively. Devices 80-86 maybe addressed on bus 10 as if they were PCI devices on bus 12. Also in this embodiment, a bus 88 is shown in ASIC 56, with the same devices as shown on bus 78 to enable an OEM to implement these ports without the need for separate input/output circuits.

Referring to FIG. 3, previously mentioned ASIC 58 is shown in a docking station 130 connected to an oscillator 91 for establishing a remote and internal clock. ASIC 58 has its lines 81 and 83 connected through a connection assembly 90 for connection to a keyboard and mouse, respectively. Serial lines 85 and parallel lines 87 are shown connected to transceivers 92 and 94, respectively, which then also connect to connection assembly 90 for connection to various parallel and serial peripherals, such as printers and modems.

ASIC 58 is also shown connected to previously mentioned secondary bus 12. Bus 12 is shown connected to an adapter card 96 to allow the PCI bus 12 to communicate with an IDE device such as a hard drive, backup tape drive, CD-ROM drive, etc. Another adapter card 98 is shown for allowing communications from bus 12 to a universal serial port (USB). A network interface card 100 will allow communications through bus 12 to various networks operating under the Ethernet standard, Token Ring standard, etc. Video adapter card 102 (also referred to as a video means) allows the user to operate another monitor. Add-on card 104 may be one of a variety of cards selected by the user to perform a useful function. While this embodiment shows various functions being implemented by add-on cards, other embodiments may implement one or more of these function on a common circuit board in the dock (e.g., all functions excluding perhaps the IDE adapter card).

ASIC 58 communicates through receiver/transmitter 106, which provides a physical interface through a terminal connector 108 to cable 40, 46. Connector 108 may be a 20 pin connector capable of carrying high speed signals with EMI shielding (for example a low force helix connector of the type offered by Molex Incorporated), although other connector types may be used instead. The opposite end of cable 40, 46 connects through a gigabit, terminal connector 110 to physical interface 112, which acts as a receiver/transmitter. Interface 112 is shown connected to previously mentioned first ASIC 56, which is also shown connected to an oscillator 114 to establish a local clock signal. This specific design contemplates using an external transmitter/receiver (external SERDES of lines 27,29, 31, and 33 of FIG. 1), although other embodiments can eliminate these external devices in favor of the internal devices in ASIC's 56 and 58.

This embodiment is adapted to cooperate with a portable computer having a PCMCIA 32-bit bus 10, although other types of computers can be serviced. Accordingly, ASIC 56 is shown in a package 116 having an outline complying with the PCMCIA standard and allowing package 116 to fit into a slot in a portable computer. Therefore, ASIC 56 has a connector 118 for connection to bus 10. Cable 40, 46 will typically be permanently connected to package 116, but a detachable connector may be used in other embodiments, where a user wishes to leave package 116 inside the portable computer.

Power supply 120 is shown producing a variety of supply voltages used to power various components. In some embodiments, one of these supply lines can be connected directly to the portable computer to charge its battery.

Referring to FIG. 4, the previously mentioned simplex links 40 and 46 are shown as twin axial lines 40A and 46A, wrapped with individual shields 40B and 46B. A single shield 122 encircles the lines 40 and 46. Four parallel wires 124 are shown (although a greater number may be used in other embodiments) mounted around the periphery of shields 122 for various purposes. These wires 124 may carry power management signals, dock control signals or other signals that may be useful in an interface between a docking station and a portable computer. While twin axial lines offer high performance, twisted pairs or other transmission media may be used in other embodiments where the transmission distance is not as great and where the bit transfer speed need not be as high. While a hard wire connection is illustrated, in other embodiments a wireless or other type of connection can be employed instead.

Referring to FIG. 5, previously mentioned package 116 is shown in position to be connected to a PCMCIA slot in portable computer 126. Computer 126 is shown having primary bus 10 and a host processor 128. Package 116 is shown connected through cable 40, 46 to previously mentioned connector 108 on docking station 130. Previously mentioned docking station 130 is shown connecting through PS/2 ports to keyboard 132 and mouse 134. A printer 136 is shown connected to a parallel port in docking station 130. Previously mentioned video means 102 is shown connected to a monitor 138. Docking station 130 is also shown with an internal hard drive 140 connecting to the adapter card previously mentioned. A CD-ROM drive 142 is also shown mounted in docking station 130 and connects to the secondary bus through an appropriate adapter card (not shown). Previously mentioned add-on card 104 is shown with its own cable 144.

Referring to FIG. 6, a modified portable computer 126′ is again shown with a host processor 128 and primary bus 10. In this embodiment however, portable computer 126′ contains previously mentioned ASIC 56. Thus there is no circuitry required (other than perhaps drivers) between ASIC 56 and cable 40,46. In this case, the laptop end of cable 40, 46 has a connector 143 similar to the one on the opposite end of the cable (connector 108 of FIG. 5). Connector 143 is designed to mate with connector 141 and support the high-speed link. As before, connectors 141 and 143 can also carry various power management signals, and other signals associated with a docking system.

An important advantage of this arrangement is the fact that ASIC 56 contains circuitry for providing ports, such as a serial port, a parallel port, PS/2 ports for a mouse and keyboard, and the like. Since portable computer 126′ would ordinarily provide such ports, ASIC 56 simplifies the design of the portable computer. This advantage is in addition to the advantage of having a single ASIC design (that is, ASIC's 56 and 58 are structured identically), which single design is capable of operating at either the portable computer or the docking station, thereby simplifying the ASIC design and reducing stocking requirements, etc.

To facilitate an understanding of the principles associated with the foregoing apparatus, its operation will be briefly described. This operation will be described in connection with the docking system of FIGS. 3 and 5 (which generally relates to FIG. 2), although operation would be similar for other types of arrangements. For the docking system, a connection is established by plugging package 116 (FIG. 5) into portable computer 126. This establishes a link between the primary bus 10 and ASIC 56 (FIG. 3).

At this time an initiator (the host processor or a master) having access to primary bus 10 may assert control of the bus. An initiator will normally send a request signal to an internal arbiter (not shown) that will eventually grant control to this initiator. In any event, the initiator asserting control over primary bus 10 will exchange the appropriate handshaking signals and drive an address onto the bus 10. Control signals simultaneously applied to the signaling lines of bus 10 will indicate whether the transaction is a read, write, or other type of transaction.

Interface 14 (FIG. 2) will examine the pending address and determine whether it represents a transaction with devices on the other side of the bridge (that is, secondary bus 12) or with the bridge itself. Configuration register 68 has already been loaded in the usual manner with information that indicates a range of addresses defining the jurisdiction of the interface 14.

Assuming a write transaction is pending on bus 10, interface 14 will transfer 32 address bits together with four control bits (PCI standard) to FIFO register 18 (FIG. 1). Encoder 26 will add at least two additional bits tagging this information as an addressing cycle. The information is then broken into frames that can carry flow control and other signals before being transmitted serially over link 40.

Without waiting, interface 14 will proceed to a data cycle and accept up to 32 bits of data from bus 10 together with four byte enable bits. As before, this information will be tagged, supplemented with additional information and broken into frames for serial transmission over link 40. This transmitted information will be tagged to indicate whether it is part of a burst or a single cycle.

Upon receipt, decoder 32 restores the frames into the original 38 bit format and loads the last two described cycles onto the stack of register 24. Interface 16 eventually notices the first cycle as an addressing cycle in a write request. Interface 16 then negotiates control over bus 12 in the usual fashion and applies the address to bus 12. A device on bus 12 will respond to the write request by performing the usual handshaking.

Next, interface 16 will drive the write data stacked on register 24 into bus 12. If this transaction is a burst, interface 16 will continue to drive data onto bus 12 by fetching it from register 24. If however this transaction is a single cycle write, interface 16 will close the transaction on bus 12 and load an acknowledgment into register 20. Since this acknowledgment need not carry data or address information, a unique code may be placed into register 20, so that encoder 28 can appropriately tag this line before parsing it into frames for transmission over link 46. Upon receipt, decoder 30 will produce a unique code that is loaded into register 22 and eventually forwarded to interface 14, which sends an acknowledgment to the device on bus 10 that the write has succeeded.

If the initiator instead sets its control bits during the address cycle to indicate a read request, interface 14 would also accept this cycle, if it has jurisdiction. Interface 14 will also signal the initiator on bus 10 that it is not ready to return data (e.g., a retry signal, which may be the stop signal as defined under the PCI standard). The initiator can still start (but not finish) a data cycle by driving its signaling lines on bus 10 with byte enable information. Using the same technique, the address information, followed by the byte enable information, will be accepted by interface 14 and loaded with tags into register 18. These two lines of information will be then encoded and transmitted serially over link 40. Upon receipt, this information will be loaded into the stack of register 24. Eventually, interface 16 will notice the first item as a read request and drive this address information onto secondary bus 12. A device on bus 12 will respond and perform the appropriate handshaking. Interface 16 will then forward the next item of information from register 24 containing the byte enables, onto bus 12 so the target device can respond with the requested data. This responsive data is loaded by interface 16 into register 20. If pre-fetching is indicated, interface 16 will initiate a number of successive read cycles to accumulate data in register 20 from sequential addresses that may or may not be requested by the initiator.

As before, this data is tagged, broken into frames and sent serially over link 46 to be decoded and loaded into register 22. The transmitted data can include pre-fetched data that will be accumulated in register 22. Interface 14 transfers the first item of returning data onto primary bus 10, and allows the initiator to proceed to another read cycle if desired. If another read cycle is conducted as part of a burst transaction, the requested data will already be present in register 22 for immediate delivery by interface 14 to bus 10. If these pre-fetched data are not requested for the next cycle, then they are discarded.

Eventually the initiator will relinquish control of bus 10. Next, an initiator on bus 12 may send a request for control of bus 12 to arbiter 70 (FIG. 2). If arbiter 70 grants control, the initiator may make a read or write request by driving an address onto bus 12. Interface 16 will respond if this address does not fall within the jurisdictional range of addresses specified in configuration register 67 (indicating the higher level bus 10 may have jurisdiction). In the same manner as before, but with a reversed flow over links 40, 46, interface 16 may accept address and data cycles and communicate them across link 40, 46. Before being granted bus 10, interface 14 will send a request to an arbiter (not shown) associated with bus 10.

In some instances, an initiator on primary bus 10 will wish to read from, or write to, port means 80, 82, 84, or 86. These four items are arranged to act as devices under the PCI standard. Interface 16 will therefore act as before, except that information will be routed not through bus 12, but through bus 78.

Other types of transactions may be performed, including reads and writes to the configuration registers 67 and 68 (FIG. 2). Other types of transactions, as defined under the PCI standard (or other bus standards) may be performed as well.

Interrupt signals may be generated by the ports or other devices in ASIC 58. Also external interrupts may be received as indicated by block 34. As noted before, interrupt signals may be embedded in the code sent over link 46. Upon receipt, system 60 decodes the interrupts and forwards them on to block 57, which may be simply one or more pins from ASIC 56 (implementing, for example, INTA of the PCI standard). This interrupt signal can either be sent over the bus 10 or to an interrupt controller that forwards interrupts to the host processor. System errors may be forwarded in a similar fashion to produce an output on a pin of ASIC 56 that can be routed directly to bus 10 or processed using dedicated hardware. The designer may wish to send individual status signals, which can be handled in a similar fashion along link 40, 46.

The use of the docking methods taught in the '752 patent can be applied to the teachings of the present invention to achieve inventive results.

U.S. Pat. No. 6,256,691 to Moroz, et al., entitled Universal Docking Station, which was filed on Jan. 11, 2000 and which issued on Jul. 3, 2001, and which is incorporated herein by reference, discloses additional methods of transferring data between a mobile computer and a regular, prior-art (sometimes called a “dumb”) docking station (the '691 patent). Relevant sections of the '691 patent are here presented, with figures provided for the '691 patent designated below by “('691 prior art)”:

The universal docking station or expansion base of the present invention allows a portable computer user to interface a portable computer to several different peripheral devices, such as CD-ROMs, Hard Disk Drives, Floppy Disk Drives, Tape Backups, standard size keyboards and mice, standard size VGA/super VGA monitors, networks, and other peripherals that typically utilize serial and/or parallel ports.

Rather than using proprietary connectors to connect the computer to the docking station, the present invention accomplishes this task using a standard universal interface. One such interface is the Personal Computer Memory Card International Association (“PCMCIA”) slot, port or socket provided on most portable computers. To interface with the PCMCIA slot, the docking station uses a PCMCIA card (“PC Card”) as the connection between the portable computer and the docking station. With this arrangement, portable computer users can connect their portable computers to multiple peripherals with one PCMCIA card. Because PCMCIA ports on portable computers are almost identical physically and electrically from computer to computer, the present docking station will work with almost any portable computer having such a port. With this arrangement, the docking station of the present invention can be positioned not only at a user's office and home, but at airports, libraries, business associates' offices, and virtually anywhere else computers are used. Portable computer users would no longer be limited by the make and model of computer they carry.

[image]

[image]

[image]

[image]

[image]

[image]

Background on 16-Bit PCMCIA cards can be found in Mindshare, Inc. & Don Anderson, PCMCIA System Architecture 16 Bit PC Cards, Second Edition (Addison-Wesley Publishing Company 1995), which is hereby incorporated by reference. Background on 32-bit PCMCIA standard known as “card bus” can be found in Mind Share, Inc., Card Bus System Architecture (Addison-Wesley Publishing Company 1995), which is hereby incorporated by reference.

Referring to the drawings, particularly FIG. 1, a portable computer 101 having a PCMCIA port 102 is connected to a PCMCIA card 105 which interfaces to a docking station 103. The PCMCIA card 105 completes the interface between the portable computer 101 and the docking station 103. Several peripheral devices 106 are coupled to the docking station 103. Possible peripheral devices include: keyboard 107, joy stick 109, mouse 111, modem 113, network interface 115, hard disk 117, floppy disk 119, CD ROM 121, tape backup 123, printer 125, and monitor 127.

In one embodiment, the docking station 103 contains two standard expansion slots 129 and 131 configured and arranged to receive any combination of two of the following standard internal peripheral devices: hard disk 117, floppy drive 119, CD ROM 121 and tape backup 123. Other embodiments of the present invention may provide for additional expansion slots for receiving additional internal peripheral devices.

As indicated above, the portable computer 101 contains at least one PCMCIA slot. The portable computer 101 also includes a central processing unit (CPU) coupled to a Read Only Memory (ROM) and Random Access Memory (RAM). The computer communicates with the PCMCIA slot and other internal and external components through an internal or input/output (I/O) bus. A controller or Host Bus Adaptor (HBA) links signals coming from the PCMCIA slot (or from a PCMCIA card installed in the slot) to the I/O bus of the portable computer. The computer may also include one or more data storage devices, such as a hard disk drive, a floppy disk drive, and CD-ROM drive. In one embodiment, software used in connection with the present invention may be stored and distributed on a CD-ROM, which may be inserted into and read by the CD-ROM drive. The computer is also coupled to a display, and a user input device such as a mouse or keyboard.

A memory window can be created in the portable computer's address space into which memory and configuration registers of the PCMCIA card can be individually mapped. This memory window can be set up by a device driver of the PCMCIA card, and typically remains the same size and keeps the same memory location on the portable computer.

Referring to FIG. 2, the docking station 103 interfaces to the computer 101 via a PCMCIA bus 201 on the computer 101. The computer 101 includes a PCMCIA slot or socket connected to the PCMCIA bus 201, into which a PCMCIA card can be inserted to connect the PCMCIA 20 card to the PCMCIA bus 201. As used herein, a PCMCIA card refers, generically, to a standardized interface between a peripheral device and an internal bus of a computer. Typically, the PCMCIA card will be of a standard length and width, and will have a thickness determined by the card type (e.g., Type I=3.3 mm thick; Type II=5.0 mm thick; Type III=10.5 mm thick). The PCMCIA card is configured to fit into a PCMCIA slot or socket. When inserted into the PCMCIA slot or socket, the PCMCIA card can be connected to a wide variety of host buses, typically via host bus adapters designed for a particular bus interface. The PCMCIA bus 201 is an expansion of the computer's internal bus, and allows devices connected to the PCMCIA port to be accessed by the computer as if they were inside the computer. The PCMCIA physical interface allows for devices to be inserted and removed at anytime from the computer.

The PCMCIA bus 201 operatively couples a PCMCIA control bus 239, an address bus 241 and a data bus 243 to core logic 202 of the docking station 103 to the computer 101. The core logic 202 includes address decode and control logic 203, configuration registers 205, and attribute memory 207.

In one exemplary embodiment, the address decode and control logic 203 is implemented using field programmable gate arrays (FPGA). Alternatively, the address decode and control logic 203 could be implemented using a program array logic (PAL) or other similar programmable devices or custom integrated circuits (IC) so long as the particular implementation can handle the timing requirements of the PCMCIA bus 201 as well as all of the peripheral devices 106 connected to the docking station 103.

In the exemplary embodiment, the configuration registers 205 contain five registers. The first configuration register is a standard PCMCIA register needed for all PCMCIA devices, commonly referred to as the configuration option register. This register contains 8 bits to enable the PCMCIA card to behave as an I/O card and also has a bit that resets the card to a known state. The second configuration register is a 16 bit register that contains the I/O address for the configuration registers of the different peripheral devices attached to the docking station 103. The third register is an interrupt flag which is an 8 bit register that contains a bit for each device to interrupt the computer for services. The fourth register is a 16 bit register that is loaded with the address for the IOIS 16 signal used by the IDE interface. The IOIS 16 is a signal used to inform the computer that a device desires to carry out a 16 bit transfer as opposed to an 8 bit transfer to the computer. The last register is a keyboard configuration register which is a 16 bit register that is loaded with the I/O address that the keyboard controller needs to be mapped to in the system.

In the above described exemplary embodiment, the configuration registers 205 are implemented using a field programmable gate array (FPGA). The configuration registers 205 could also be implemented using random access memory (RAM) or a programmable array logic (PAL) device. Different size registers may also be sued as dictated by the actual implementation.

The attribute memory 207 is implemented in the exemplary embodiment with an electronically erasable programmable read only memory (EEPROM) or other suitable standard nonvolatile memory. In one embodiment, only about 1024 bytes of memory are required to store all the values needed for the docking station 103.

Peripheral devices 106 can be connected to the docking station 103 through appropriate connectors (223-237). Once connected, the peripheral devices 106 interface through the address decode and control logic 203.

A parallel connector is connected through connection 249 to a parallel controller 209. The parallel controller 209 is connected to the address decode and control logic 203 via control bus 245 and address bus 247. Parallel controller 209 is also connected to configuration registers 205 with control bus 245 and address bus 247. A data bus 243 is linked to, and can provide data to, the configuration registers 205, the attribute memory 207, and the parallel controller 209. The parallel controller 209 may be implemented, for example, using a standard 8255 compatible parallel controller used on IBM XT/AT compatible computers. This supports the optional PS/2 bidirectional parallel port (SPP), the Enhanced Parallel Port (EPP) and the Extended Capabilities Port (ECP) modes. This interface is useful for connecting printers, removable media high density storage devices and scanners to the docking station 103. A Standard Microsystems Corporation (SMC) FDC37C93X Plug and Play Compatible Ultra I/O Controller includes a parallel port and can be used for this purpose.

A serial connector 225 is connected via connection 251 to a serial controller 211. The serial controller 211 is connected to the address decode and control logic 203, configuration registers 205 by way of control bus 245, address bus 247 and data bus 243, as indicated in FIG. 2. The serial controller 211 may be a NS16C550 compatible serial controller or other serial controller that can handle high speed communication (i.e., communication above 460K Baud), and has a built in FIFO for handling data received by the serial port at a rate faster than can be sent through the interface to the computer. The serial controller may be a standard 16C550 compatible Universal Asynchronous Receiver/Transmitter (UART), for example, with a 16 byte FIFO. The UART performs the serial-to-parallel conversion for receiving characters and the parallel-to-serial conversion for transmitting characters. This UART allows for data rates from 50 to 460.8K baud. The character options are programmable for 1 start; 1, 1.5 or 2 stop bits; even, odd, sticky or no parity; and prioritized interrupts. The UART contains a programmable baud rate generator that is capable of dividing the input clock or crystal by a number from 1 to 65535. The UART is also capable of supporting Musical Instrument Digital Interface (MIDI) data rate. An SMC FDC37C93X Plug and Play Compatible Ultra I/O Controller can be used for this purpose. Other serial controllers may also be used so long as they support a communications speed of 460K baud and contain a FIFO for handling data overflow.

An Integrated Drive Electronic (IDE) connector 227 is connected via connection 253 to IDE interface logic 213. The IDE enables hard disk drives with embedded controllers to be interfaced to the host processor. The IDE interface performs the address decoding for the IDE device. This interface also supports devices such as CD-ROM drives and newer high density removable storage devices. The IDE 213 includes an address decoder for the specific drive or mass storage device to be 20 interfaced to, and interrupt circuitry to allow the device to request service from the computer. The interrupt source goes back through the control bus 245 through the address decode and control logic 203 back into the PCMCIA bus 201. In an exemplary embodiment, the SMC FDC37C93X Plug and Play Compatible Ultra I/O Controller provides the IDE interface.

A keyboard connector 229 is connected via connection 255 to a keyboard and mouse controller 215. A mouse connector 231 is also connected via connection 257 to the keyboard and mouse controller 215. The keyboard and mouse controller 215 interfaces through the control bus 245, address bus 247 and data bus 243. The keyboard and mouse controller 215 should contain means for communicating to a keyboard and a mouse and means for interfacing with a computer. The keyboard and mouse controller 215 may be implemented using a universal keyboard control with a standard Intel 8042 micro controller CPU core. The SMC FDC37C93X Plug and Play Compatible Ultra I/O Controller, for example, provides the keyboard and mouse controller 215. Other standard keyboard and mouse controllers may also be used.

A floppy disk connector 233 is connected to the floppy disk controller (FDC) 217 via connection 259. The FDC 217 is connected to the control bus 245, address bus 247 and data bus 243. An IBM compatible FDC can be used, and preferably one with a CMOS 755 floppy disk controller that supports a 2.88 megabyte super floppy drive. This FDC 217 can handle up to two floppy disk drives or tape backups. The FDC integrates the functions of the Formatter/Controller, Digital Separator. Write Precompensation and Data Rate Selection logic for IBM XT/AT compatible FDC are also provided. The true CMOS 765B core guarantees 100% IBM PC XT/AT computability in addition to providing data overflow and underflow protection. In an exemplary embodiment, the SMC FDC37C93X Plug and Play Compatible Ultra I/O Controller provides the FDC.

A VGA connector 235 is connected to a VGA controller 219 via connection 261. The VGA connector 235 interfaces through the control bus 245, address bus 247 and data bus 243. The VGA controller 261 can have some VGA memory integrated into it, support up to 1024 by 756 pixels, and be compatible with a super VGA monitor.

A network connector 237 is connected to a network controller 221 through connection 263. The network controller 221 interfaces through the control bus 245, address bus 247 and data bus 243. Between a 10 megabyte and a 100 megabyte controller can be supported. In the exemplary embodiment, the network controller 221 is an Ethernet controller.

As indicated, the keyboard and mouse controller 215, FDC 217, parallel controller 209, serial controller 211, and IDE interface 213 can be implemented using a Standard Microsystems Corporation (SMC) FDC37C93X Plug and Play Compatible Ultra I/O Controller. This device incorporates a keyboard interface, SMC's true CMOS 765B floppy disk controller, advance digital separator, 16 byte data FIFO, 16C550 compatible UARTs, a Multi-Mode parallel port and an IDE interface. The FDC37C93X also provides support for the ISAPlug-andPlay Standard (Version 1.0a) and provides for the recommended functionality to support Windows '95.

Most PCMCIA socket controllers designed into most computers have a limited I/O window size. Typically, only two I/O windows are permitted. This will allow for one or two functions to have I/O ports. With more than two functions on the docking station it is necessary to combine all of the I/O ports into two contiguous pieces of I/O memory.

Almost all of the functions on the SMC chip can be relocated in I/O address space via configuration registers. The only function that is fixed is the keyboard and mouse controller. To accommodate this a Xilinx FPGA is built into the hardware of the docking station. The Xilinx device includes logic to match an address and output the appropriate address to the SMC chip.

FIG. 3 shows a flow chart depicting steps performed in inserting the docking station device driver 301 into the RAM of the portable computer 101. Processing begins with decision step 303 which detects whether card services (a piece of software that is used to interface with the PCMCIA port at a high level) is installed on the computer; if not, an error is flagged at step 307, processing stops, and the device driver is not installed into the operating system. If card services is installed, processing continues with step 311 wherein the device driver registers with card services and sets up a call back handler, thereby allowing card services to inform the docking station device driver of events that happen in the PCMCIA port such as a PCMCIA card being inserted or removed. After the device driver is registered with card services, processing continues with step 313 which polls for interrupt vectors and loads the interrupt vectors into memory to allow the device driver to handle different functions of the docking station. Once in memory, the device driver stays in memory waiting for one of the callback events from card services to tell it that the docking station PCMCIA card has been inserted into the computer's PCMCIA port as shown in item 317.

The PCMCIA standard specifies that all PCMCIA devices must behave as a memory device until configured by the host computer. After configuration, the PCMCIA device must convert some of the interface pins to the PCMCIA bus to support the I/O interface. This is accomplished in one embodiment of the universal docking station 103 by using a Xilinx FPGA to control the functions of the flexible interface pins. All PCMCIA devices must also have memory on board that identifies the device's functions and capabilities. This is accomplished in the exemplary embodiment of the present invention by using a 2K EEPROM that is accessible by the computer at any time. The EEPROM also allows for software to write new information to it when upgrades or modifications are necessary.

FIG. 4 depicts the steps performed during card configuration. Processing begins at step 401 when a PCMCIA card is inserted into the PCMCIA port on the computer, and card services informs the device driver through the callback handler that a card has been inserted. Next, in step 403, the device driver asks card services for the manufacture ID of the card that was inserted. If the card inserted is the docking station PCMCIA card, the manufacturer ID is stored in attribute memory 207. In decision step 405, the manufacturer ID of the card inserted is compared to the ID designated for the docking station; if no match is found, the system ignores the card as shown in step 407 and continues waiting for another card to be installed. If the manufacturer ID is correct, processing continues with step 409 which gets the first configuration entry that is stored in the attribute memory on the card.

Next, the device driver tries to configure the I/O port and different interfaces needed for using the docking station card in the system given the particular configuration entry. The first step is the I/O port step 411 which is requested from card services and card services either allows the docking station card to have the I/O port or not. If not, the system will determine in decision step 413 whether the configuration allows other I/O ports to be used. If there are more I/O ports in this particular configuration, the system will return to step 411 to try requesting the next I/O port. This routine will continue until an I/O port is successfully requested or all I/O ports of this particular configuration entry are exhausted. If there are no more I/O ports in the particular configuration, decision step 423 determines whether there are other configurations available. If so, step 425 gets the next configuration entry and processing continues at step 411. If no other configurations exist, an error is reported at step 433.

If an I/O port is successfully requested in step 411, the processing will continue with step 415 which requests an interrupt. A similar process will happen with respect to the interrupt as with the I/O port; if the system does not get an interrupt, decision step 417 checks the configuration to see if another interrupt is allowed. If there is a possibility of another interrupt, it will go back and try to request the next interrupt. This process will continue until it either runs out of possible interrupts to try or it successfully allocates an interrupt for use with the docking station card. If it runs out of interrupts to try, step 418 releases the I/O port previously requested in step 411, and decision step 423 determines whether other configurations exist. If not, step 433 reports an error. If so, step 425 gets the next configuration entry and processing starts over at step 411.

If an interrupt is successfully requested in step 415, step 419 requests a direct memory address (DMA) channel. If the request fails, decision step 421 determines whether the configuration supports other DMA's. If so, step 419 will request that DMA, and this process will continue until it either runs out of possible DMAs or it successfully allocates a DMA channel. If decision step 421 determines that no more DMAs exist for the particular configuration, step 422 releases the I/O port and the interrupt, and moves to decision step 423 to determine if other configurations are available. If so, step 425 gets the next configuration and processing continues at step 411. If not, step 433 reports an error.

If a DMA channel is successfully requested in step 419, step 421 requests a memory block. If step 421 fails, step 428 releases the I/O port, the IRQ, and the DMA channel. Next, decision step 423 determines whether another configuration is available. If not, step 433 reports an error. If so, step 425 gets the next configuration entry and processing continues from step 411.

Upon successfully requesting the I/O, the IRQ, DMA and memory, step 427 requests configuration for the docking station, step 429 configures the hardware on the docking station board, and step 431 indicates that card configuration is complete.

FIG. 5 shows a flowchart of the interrupt service routine. The interrupt service routine comprises a series of steps performed when one of the peripheral devices 106 connected to the docking station 103 requests service from the computer 101 by setting its interrupt flag in the interrupt flag register of the control logic 203.

The PCMCIA specification and available controller hardware support only one interrupt per card. This presents a problem when more than one function on a card needs to interrupt the host computer for servicing. The PCMCIA 1995 specification solves this issue by having the card services (high level interface to PCMCIA devices for applications) handle the interrupts from a card. When a card is configured the card services starts with the first function and assigns it an interrupt if needed. Card services then stores the vector for this interrupt in a table and places its own interrupt vector in the appropriate memory location. When card services configures the next function on the card it stores that function's interrupt vector in the table next to the first function's interrupt vector. This continues until all functions are configured.

When an interrupt occurs, card services' interrupt handler is called from the vector in memory. Card services will then interrogate the PCMCIA cards interrupt status register to identify the source of the interrupt. Card services will then call the appropriate service routine for the function by calling the function pointed to by the vector in the stored table.

Step 503 reads an interrupt status register on the docking station 103. In a preferred embodiment, the interrupt status register will be in the configuration register 205 shown in FIG. 2, and have one bit in it for each function of the docking station 103. The interrupt service routine will then look at these bits and decide whether or not one of the devices is in need of service. If any of the devices connected to the expansion box set their interrupt flag in the interrupt flag register, the control logic 203 will then send the interrupt flag to the PCMCIA bus which will cause a hardware interface on the particular interrupt line that has been configured in accordance with FIG. 4.

After the interrupt service handler has read the interrupt status register, it decides which interrupts to handle in a prioritized fashion starting with the IDE interface in decision step 505, and proceeding downward in priority as shown in FIG. 5, until it reaches the keyboard which is lowest in priority. If decision step 505 determines that the flag is set for the IDE, then step 523 branches to the IDE interrupt service routine. Upon completion of this interrupt service routine, step 521 cleans up any registers that may have information pushed on to their stacks and returns from the interrupt. If the flag is not set for the IDE, decision step 507 determines whether the interrupt flag is set for the VGA. If so, step 525 branches to the VGA interrupt service routine.

If decision step 509 determines that the flag is set for the floppy disk controller, step 527 branches to the floppy interrupt service routine. If decision step 511 determines that the flag is set for the serial port, step 529 branches to the serial interrupt service routine. If decision step 513 determines that the flag is set to the parallel port, step 531 branches to the parallel port interrupt service routine. If decision step 515 determines that the flag is set to a network, step 533 branches to the network interrupt service routine. If decision step 517 determines that the flag is set to the mouse, step 535 gets the mouse event from the keyboard controller and puts it in the mouse input buffer. If decision step 519 determines that the flag was set by the keyboard, step 537 gets the keystroke from the input buffer of the keyboard controller and puts it into the BIOS input buffer of the operating system on the computer.

Although priority may be altered from that shown in FIG. 5, the priority shown has certain advantages over other possible schemes because of the relative speed of each device and the capability of the devices to hold data before being manipulated. Those devices that have room to store data for longer periods of time (e.g., keyboard) will be lower in priority than other devices which will throw away this information in a short period of time if it does not get taken out of the buffer.

An example of the serial controller 211 taking control of the PCMCIA bus 201 follows. The serial controller 211 would be configured to receive information from the serial connector 225 and would then send this data through the connections of 251 into the serial controller 211. The serial controller 211 would then request servicing to the computer 101 by setting the interrupt flag through the control bus 245 to the configuration registers 205. The configuration registers 205 would then set the interrupt flag through the control bus 245 to the address, decode and control logic 203 and the decode and control logic would send the signal through 239 to the PCMCIA bus 201.

FIG. 6 shows a timing diagram for 110 write timing and illustrates a solution to the type of problems encountered when interfacing standard peripheral devices 106 to the PCMCIA port. Because PCMCIA was originally designed for memory devices, the specifications for interfacing with I/O devices are more constrained than other specifications for interfacing with I/O devices. Nonetheless, in order to interface with I/O devices through the PCMCIA port, one must somehow meet these constraints. This problem has been addressed conventionally by designing the I/O device with the PCMCIA constraints in mind, and, therefore, by designing the constraints right into the device. In contrast, the present invention allows the use of standard off-the-shelf devices that would normally be connected to the ISA (Industry Standard Architecture) bus of a computer, and use them on the PCMCIA bus. In other words, the PCMCIA interface is used in the present invention in a manner not contemplated by its design, and yet is also being used to interface off-the-shelf peripherals. The present invention addresses these competing interests.

Most IDE devices are designed to conform to the ANSI AT Attachment Interface for Disk Drives specification (ANSI X3.221-1994). This specification was designed to interface IDE devices directly to an Industry Standard Architecture (ISA) bus. This bus differs id some ways from the PCMCIA bus. In order to allow a standard IDE device to be connected to the docking station, the timing of some of the main control signals is modified since the timing constraints of a standard IDE device do not match that of the PC bus.

For example, the specification for PCMCIA does not require that the data bus be held active for any amount of time after a write signal goes high, but I/O devices need the data bus to be stable for a period of time after the I/O write signal goes inactive. The present invention overcomes this problem by extending the period of time the data bus is allowed to remain stable. In an exemplary embodiment, the period of time the data bus is allowed to remain stable is extended by activating early write signals.

To accomplish this task a Xilinx FPGA was designed into the hardware of the docking station. This device allows for a large amount of flexible glue logic to be utilized without taking up a large amount of printed circuit board real-estate and for a reasonable cost.

By way of example, if the computer 101 writes a byte of information to a peripheral device 106, e.g., the serial controller, the computer 101 first sets up the address bus signal 601. When the address bus signal 601 settles out and is determined to be the correct address as in the address and decode logic 203 in FIG. 2, the computer 101 waits for a short period of time and then either activates the IOIS16 signal 611 (for a 16 bit transfer) or does not activate the IOIS16 line 611 (for an 8 bit transfer). The IOIS16 signal 611 is used to inform the host computer that the IDE device would like to transfer 16 bits of data instead of 8. This signal is output from an IDE device and is active within 90 ns from the activation of a valid address. The PCMCIA spec requires this signal to be active within 35 ns of a valid address.

To overcome this problem the Xilinx FPGA on the docking station main printed circuit board (PCB) has a logic circuit in it to match the valid address and assert the IOIS16 line within the PCMCIA timing constraint.

Then the computer 101 activates the register signal 603 in the PCMCIA port. At about the same time, the computer activates CE[1:0] 605. CE[0] would be activated for an 8 bit transfer and both CE[1:0] would be activated for a 16 bit transfer. About a third period of time after that, the computer would activate the I/O write signal 607 letting the peripheral device that is addressed activate the address line 601, telling the device to set up the address line 601 of the data bus for the value that is going to be written to it. The Din signal 615 represents the data being sent by the computer. It settles out after a period of time. The peripheral device also sets the wait signal 613 to tell the computer to extend this write period for a longer period of time than a standard write. The Wait signal is another signal that could not meet the time constraints of the PCMCIA interface. This signal is asserted by an I/O device to inform the host computer that it needs more time to accomplish a task. The timing specs for PCMCIA and IDE both require this signal to be active within 35 ns. However, because all of the other timing critical signals must run through the Xilinx and other hardware on the PCB, this timing was not possible to meet. Therefore the Xilinx FPGA was used to activate an early wait signal. This signal delays the host computer by 100 to 500 ns to allow the other signals to settle.

At that point, the hardware on the docking station sets the early I/O write signal 609 so that the peripheral device, in this case the serial port, would see the actual write signal happen and on the other edge of that write signal (i.e., the rising edge) the device would then write the data on the data bus 615 into the particular register that is mapped out by the address bus 601. This early I/O write signal is activated a period of time before the actual I/O write signal occurs to allow the device to have valid data on the data bus 615 for a longer period of time. The I/O write signal then goes inactive, the CE[1:0] signal 605 goes inactive, and the read signals go inactive. Finally, the end of the address signal 601 becomes unstable.

FIG. 7 shows a timing diagram showing the read timing used to interface with the PCMCIA port. The address bus 701 is the first signal to become stable and settle on the bus to indicate to the docking station 103 that one of the peripheral devices 106 on the docking station is to be addressed. The REG signal 703 then goes low and CE[1:0] (again, CE[0] would be activated for an 8 bit transfer and both CE[1:0] would be activated for a 16 bit transfer) becomes low. The control logic 203 in FIG. 2 activates the IOIS16 signal if a 16 bit transfer is desired for this particular read cycle. After the IOIS16, REG, and CE[1:0] signals have become low, the I/O read signal 707 would go low. This would indicate to the peripheral device (e.g., the serial port) that the computer wants to read information from it. The INPACK signal 709 would then go low to access a PCMCIA card register and notify the HBA that access belongs to the PCMCIA card. This allows the PCMCIA interface to drive the signal onto the internal bus of the computer. The docking station would then bring the wait signal 713 low to extend the time of the read cycle from the computer. This causes the computer to stretch out the read timing to allow the peripheral device to activate the data output 715 in a reasonable amount of time so that the computer can handle reading this information back and so that data would then become stable on the data bus. The read signal 707 would then be brought back high causing the computer to read in the information on the data bus. On completion of the actual read on the rising edge of the read signal 707, the CEL[1:0] 705 and REG signals 703 would then be brought back high. The address signal 701 would then become unstable or start transitioning the next read value item 701 and a short time after that INPACK 709 and IOIS16 signal would be deactivated.

When the present invention is implemented without a VGA controller, a 16 bit PCMCIA port may be used. However, if a VGA controller is included in the docking station, a 32 bit PCMCIA port called “card bus” is preferable. This is because a 16 bit PCMCIA port runs at around 8 or 10 megahertz which is a fairly slow rate for updating video memory. A 32 bit PCMCIA port, however, runs at about 33 megahertz, which is similar to a PCI (Peripheral Component Interconnect) bus which is internal to computers. Interfacing the docking station to the card bus interface will provide for the wider bandwidth that is needed to handle video signals. The multiplexing and demultiplexing of the data and address lines must be properly adjusted to the PCMCIA standard chosen to ensure that the entire 16 (or 32) bit address and 16 (or 32) bit data are captured.

The use of the docking methods taught in the '691 patent can be applied to the teachings of the present invention to achieve inventive results. Furthermore, since the link between the PDA and the IDS may be a bus or a bridge, the invention may be modified to incorporate the advantages of the '691 patent or the '752 patent in ways unique from either of these patents, as well as different from other prior art, either alone or in combination.

For example, FIG. 6 illustrates one embodiment of an integrated intelligent docking station system 600 which incorporates at least one aspect of the referenced patents. With reference to FIG. 1 (which depicts an intelligent docking station system), one should notice that the integrated intelligent docking station system 600 (the integrated system 600) provides the intelligent docking station 100 of FIG. 1, and uses a first portable computer based ASIC 610 and a second intelligent docking station based ASIC 620, which function substantially as disclosed in the '752 patent. Other aspects of the referenced patents can be similarly applied to the present invention.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. In a personal digital assistant, a method of transferring a data element between an intelligent docking station and a personal digital assistant, the method comprising:
detecting a docking event when a personal digital assistant (PDA) docks with an intelligent docking station (IDS); and
interfacing the IDS to the PDA having data on a bus via a PCMCIA bus by providing data to be written to the IDS on the PCMCIA bus without waiting for the end of any current transactions.

2. In a personal digital assistant, a method of transferring a data element between an intelligent docking station and a handheld computer, the method comprising:
detecting a docking event when a personal digital assistant (PDA) docks with an intelligent docking station (IDS);
sending information between the PDA and the IDS over a single connection by serial transmission through a link in a format different from that of the PDA and the IDS; and
allowing the PDA to individually address a device in communication with the IDS, wherein the PDA uses substantially the same type of addressing as is used to access a device directly using only the IDS.

3. In an intelligent docking station, a method of transferring a data element between an intelligent docking station and a handheld computer having a PCMCIA bus, the method comprising:
detecting a docking event when a personal digital assistant (PDA) docks with an intelligent docking station (IDS);
detecting data; and
interfacing the IDS to the PDA having data on a bus via a PCMCIA bus, by:
a) providing data to be written to the PDA on the PCMCIA bus without waiting for the end of any current transactions; and
b) writing the data to the PDA via the PCMCIA bus.

4. In an intelligent docking station, a method of transferring a data element between the intelligent docking station and a handheld computer, the method comprising:
detecting a docking event when a personal digital assistant (PDA) docks with an intelligent docking station (IDS);
sending information between the IDS and the PDA over a single connection by serial transmission through a link in a format different from that of the PDA and the IDS; and
allowing a peripheral device to individually address the PDA in communication with the IDS, wherein the peripheral device uses substantially the same type of addressing as is used to access the IDS.

5. A data storage device that enables the transferring of a data element between an intelligent docking station and a personal digital assistant in an intelligent docking station system, by:
detecting a docking event when a personal digital assistant (PDA) docks with an intelligent docking station (IDS); and
interfacing the IDS to the PDA having data on a bus via a PCMCIA bus by providing data to be written to the IDS on the PCMCIA bus without waiting for the end of any current transactions.

6. A method of transferring a data element between an intelligent docking station and a handheld computer, the method comprising:
receiving a device-enabled data element at a handheld computer bus;
performing a driver conversion to convert the device-enabled data element into a bus-enabled data element;
interfacing the IDS to the PDA having data on a bus via a PCMCIA bus, by:
a) providing data to be written to the handheld computer on the PCMCIA bus without waiting for the end of any current transactions; and
b) placing the bus-enabled data element on a handheld compatible bus.

7. A method of transferring a data element between an intelligent docking station (IDS) and a handheld computer, the method comprising:
receiving a device-enabled data element at an intelligent docking station enabled co-processor;
performing a driver conversion to convert the device-enabled data element into a bus-enabled data element;
sending information between the IDS and the handheld computer over a single connection by serial transmission through a link in a format different from that of the handheld computer and the IDS.

8. A method of transferring a data element between a handheld computer and an intelligent docking station, the method comprising:
converting a handheld-enabled data element into a bus-enabled data element;
placing the bus-enabled data element on a handheld compatible bus;
interfacing the IDS to the handheld device having data on a bus via a PCMCIA bus, by:
a) providing data to be written to the intelligent docking station on the PCMCIA bus without waiting for the end of any current transactions; and
b) receiving the bus-enabled data element at an intelligent docking station enabled co-processor; and
performing a driver conversion to convert the bus-enabled data element into a device-enabled data element.

9. A method of transferring a data element between a handheld computer and an intelligent docking station, the method comprising:
converting a handheld-enabled data element into a bus-enabled data element;
placing the bus-enabled data element on a handheld compatible bus; and
sending information between the handheld computer and the IDS over a single connection by serial transmission through a link in a format different from that of the handheld computer and the IDS.
